(19) United States
(12) Patent Application Publication
(10) Pub. No.: US 2026/0065208 A1
(43) Pub. Date: Mar. 5, 2026

(54) DEAL QUALITY SCORES AND RELATED SYSTEMS, METHODS, AND DEVICES

(71) Applicant: CDK GLOBAL, LLC, Austin, TX (US)

(72) Inventors: Stanton Brooks, St. Charles, MO (US); Stanley Leong, Leander, TX (US); Northon Rodrigues, Oregon City, OR (US); Mohit Gupta, Houston, TX (US); Ganesh Ramanan, St. Charles, IL (US)

(21) Appl. No.: 18/818,457

(22) Filed: Aug. 28, 2024

(51) Int. Cl. G06Q 10/0639; G06Q 30/0601

(52) U.S. Cl. CPC G06Q 10/06393; G06Q 30/0637; G06Q 30/0641

(57) ABSTRACT

Vehicle dealership computing systems and related apparatuses, methods, and computer-readable instructions are disclosed. A sales agent graphical user interface (GUI) includes input elements configured to receive vehicle sale information for a proposed vehicle sale of a uniquely identified vehicle. The sales agent graphical user interface also displays a deal quality score for the proposed vehicle sale generated based, at least in part, on the vehicle sale information and multifactor estimates of costs incurred by a vehicle dealership for the uniquely identified vehicle. The sales agent GUI further displays an approval decision indicating whether the vehicle sale is approved by the vehicle dealership based, at least in part, on the deal quality score and one or more deal quality score threshold values.

### TECHNICAL FIELD

This disclosure relates generally to deal quality scores and related systems, methods, and devices for making vehicle dealership decisions based, at least in part, on deal quality scores.

### BACKGROUND

Accurately determining a profitability of a vehicle sale is a multifactor, complicated process. Determining rewards, compensation, and incentives for sales agents at a vehicle dealership may be equally complicated. Balancing profitability with sales agent rewards while catering to specific wishes of potential vehicle buyers can result in a mess that is difficult to sort out in a way that is agreeable to the potential vehicle buyers, the sales agents, and to the vehicle dealership.

Conventionally, a sales agent may work with a finance and insurance (F&I) manager to put together a few different offer packages to sell a specific vehicle with certain parameters of the vehicle sale varied from offer package to offer package to provide a variety of options for purchasing the vehicle. Preparation of these offer packages is complicated, may consume a significant amount of time, and requires a high degree of skill to perform. As a result, F&I managers are often the highest-paid employees at a vehicle dealership. Often, none of the offer packages end up being acceptable to the potential vehicle buyer, and the sales agent is forced to indicate that he or she must “talk to my manager” to go over new options or counteroffer packages with the F&I manager. These interruptions in the negotiation process may be unpleasant for the potential buyers, the sales agent, and/or the F&I manager.

### BRIEF SUMMARY

In some embodiments, a non-transitory computer-readable medium of a computer server, the non-transitory computer-readable medium includes sales agent computer-readable instructions stored thereon. The sales agent computer-readable instructions are configured to instruct a sales agent device to present a sales agent graphical user interface (GUI) on an electronic display of the sales agent device. The sales agent GUI includes input elements configured to receive, from a user operating the sales agent device, vehicle sale information for a proposed vehicle sale of a uniquely identified vehicle. The sales agent computer-readable instructions are also configured to instruct the sales agent device to display a deal quality score for the proposed vehicle sale. The deal quality score is generated by an artificial intelligence model based, at least in part, on the vehicle sale information and multifactor estimates of costs incurred by a vehicle dealership for the uniquely identified vehicle. The deal quality score is free of an indication of a money value for an estimated profitability of the proposed vehicle sale. The sales agent computer-readable instructions are further configured to instruct the sales agent device to display an approval decision indicating whether the vehicle sale is approved by the vehicle dealership based, at least in part, on the deal quality score and one or more deal quality score threshold values.

In some embodiments, a method of converting a general-purpose computer into a sales agent device includes storing, on one or more data storage devices of a computer server, sales agent computer-readable instructions configured to instruct one or more processors of the general-purpose computer to present a sales agent GUI on an electronic display of the general-purpose computer. The sales agent GUI includes input elements configured to receive, from a user operating the general-purpose computer, vehicle sale information for a proposed vehicle sale of a uniquely identified vehicle, display a deal quality score for the proposed vehicle sale. The deal quality score is generated by an artificial intelligence model based, at least in part, on the vehicle sale information and multifactor estimates of costs incurred by a vehicle dealership for the uniquely identified vehicle. The deal quality score is free of an indication of a money value for an estimated profitability of the proposed vehicle sale. The sales agent computer-readable instructions are also configured to instruct one or more processors of the general-purpose computer to display an approval decision indicating whether the vehicle sale is approved by the vehicle dealership based, at least in part, on the deal quality score and one or more deal quality score threshold values. The method also includes providing, by the computer server via one or more networks, the sales agent computer-readable instructions to the general-purpose computer to convert the general-purpose computer into the sales agent device.

In some embodiments, a vehicle dealership computing system includes a vehicle dealership manager device configured to present a vehicle dealership manager GUI configured to enable a vehicle dealership manager operating the vehicle dealership manager device to control parameters for training an artificial intelligence model to generate deal quality scores. The vehicle dealership computing system also includes a sales agent device configured to present a sales agent GUI including input elements configured to receive, from a user operating the sales agent device, vehicle sale information for a proposed vehicle sale of a uniquely identified vehicle. The sales agent device is also configured to display a deal quality score for the proposed vehicle sale. The deal quality score is generated by the artificial intelligence model based, at least in part, on the vehicle sale information and multifactor estimates of costs incurred by a vehicle dealership for the uniquely identified vehicle. The deal quality score is free of an indication of a money value for an estimated profitability of the proposed vehicle sale. The sales agent device is further configured to display an approval decision indicating whether the vehicle sale is approved by the vehicle dealership based, at least in part, on the deal quality score and one or more deal quality score threshold values.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a block diagram of an example of a vehicle dealership computing system, according to some embodiments;

FIG. 2 is a block diagram of another example of a vehicle dealership computing system, according to some embodiments;

FIG. 3 is a block diagram of a deal quality score system, according to some embodiments;

FIG. 4 is a flowchart illustrating a method of maintaining an artificial intelligence model that generates deal quality scores, according to some embodiments;

FIG. 5 is an example of an overall score meter, according to some embodiments

FIG. 6 is an example of a business score meter, according to some embodiments;

FIG. 7 is an example of a worker score meter, according to some embodiments;

FIG. 8 is a flowchart illustrating a method of converting a general-purpose computer into a sales agent device, according to some embodiments; and

FIG. 9 is a block diagram of a computing system, according to some embodiments.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, the term “vehicle” may refer to automobiles (e.g., cars, sedans, coupes, convertibles, hatchbacks, motorcycles, trucks, vans, sport utility vehicles, buses, jeeps, etc.), all-terrain vehicles, utility task vehicles, recreational vehicles (RVs), campers, camper trailers, airplanes, helicopters, etc. By extension, the term “vehicle dealership,” as used herein, refers to any entities (e.g., businesses, corporations, partnerships, individuals, etc.) that participate in vehicle sales.

Vehicle dealerships may employ a variety of people to act in a variety of different roles. For example, sales agents may interact directly with customers to assist customers in finding and purchasing vehicles. Sales agents may directly negotiate a sale price, perks, vehicle trade-in, features, and financing options with a customer to arrive at an acceptable price for the customer while also meeting objectives (e.g., profitability) of the vehicle dealership.

The profitability of a vehicle sale is more complicated than a simple difference between the sale price and the price the dealership initially paid for the vehicle. Vehicle dealerships may incur various other expenses along the way that may cut into profits. For example, a vehicle dealership may obtain financing for a vehicle that the dealership purchases in order to later sell the vehicle at a higher price. As a result, a vehicle dealership may pay interest on money borrowed to purchase the vehicle and the cost to the dealership for keeping the vehicle on its lot may increase with each successive interest payment made prior to selling the vehicle. A prolonged period of time that the vehicle sits in the vehicle dealership lot without being sold may reduce or completely cancel any potential profit earned for selling a vehicle, and may even result in a net loss to the vehicle dealership.

Some vehicle dealerships may also offer financing services to customers that purchase vehicles from these vehicle dealerships. Revenue (e.g., interest payments) projected to be earned through provision of financing services may increase the profitability of a vehicle sale. In some cases, the failure of a customer to finance a purchase of a vehicle using the vehicle dealership's financing services may even cause an otherwise acceptable deal to be unacceptable to the vehicle dealership. By way of non-limiting example, a failure to finance a vehicle purchase through the vehicle dealership's financing services may render an otherwise profitable sale unprofitable or may otherwise narrow the profitability beyond acceptable limits.

Other expenses that may cut into a vehicle dealership's profits for selling a vehicle may include repairs for vehicle damage, operating expenses (e.g., employee salaries and benefits, facility rental, facility utilities, equipment costs, gasoline costs, etc.), and any other expenses that are subsidized using funds earned from vehicle sales. These expenses should be factored into profitability of a vehicle sale. By way of non-limiting example, an average operating cost per vehicle sale taking into consideration these expenses may be estimated and used when assessing profitability of a vehicle sale.

It may be difficult or impossible for a sales agent at a vehicle dealership to take into consideration all the factors that influence profitability of a proposed vehicle sale in real-time while negotiating a vehicle sale with a customer. Also, bonuses and other accolades awarded to sales associates based on performance metrics different from dealership profitability (e.g., metrics such as sales volume) may fail to promote sales behaviors that ultimately increase dealership profitability. For example, a sales agent that consistently sells vehicles at prices below what would be beneficial to the dealership may sell a large number of vehicles due to the low prices. Awarding such a sales agent based on volume, however, would incentivize unprofitable sales behaviors that ultimately undermine dealership profitability.

One way to inform sales agents of a profitability of a potential sale may be to provide a system that estimates a profit resulting from a proposed vehicle sale. Although such a system may help sales agents to avoid unprofitable vehicle sales, it may not be desirable to inform sales agents of exactly how much money a vehicle dealership is estimated to earn from a vehicle sale. For example, the sales agent may feel like rewards (e.g., commissions, salaries) the sales agent earns from such a sale are disproportionately small compared to the size of the profits earned by the vehicle dealership. Also, if a potential vehicle buyer happens to see a projected profitability of a proposed vehicle sale, the potential vehicle buyer may feel like the vehicle dealership is making too much profit off of the sale and may desire to renegotiate the terms of the proposed vehicle sale.

Embodiments disclosed herein relate to artificial intelligence models that assign deal quality scores (DQSs) to indicate profitability of vehicle sales (e.g., proposed vehicle sales, completed vehicle sales). These deal quality scores may be used by sales agents in real-time during vehicle sale negotiations. These deal quality scores may also be used to assess job performance of sales agents (e.g., an average deal quality score of the sales agent's sales) and may be taken into consideration when awarding compensation, benefits, commissions, incentives, and other rewards. These deal quality scores may also be used to assess a sales manager's job performance (e.g., average deal quality scores of sales agents supervised by the sales manager). Deal quality scores may further be used to assess the performance of a particular branch of a chain of vehicle dealerships, to assess the performance of the entire chain, or to assess the performance of an isolated vehicle dealership (e.g., not part of a chain of dealerships).

Embodiments disclosed herein amount to technical improvements in the technical fields of vehicle dealership computing systems and vehicle dealership computer software. For example, in contrast to conventional approaches, embodiments disclosed herein employ an artificial intelligence model trained to generate deal quality scores determined based on learned deal data, multifactor costs to the vehicle dealership, and vehicle information. Accordingly, a sales agent GUI may inform a sales agent of an acceptability (to the vehicle dealership) of a proposed sale via deal quality scores without showing money amounts for projected profits and without the need for the sales agent to repeatedly leave a potential buyer waiting while the sales agent discusses the proposed vehicle sale with a manager. Conventional approaches did not use artificial intelligence models, and did not use systems that take learned deal data and multifactor cost estimates as inputs in conveying a sense of a profitability to a sales agent. Conventional approaches also did not provide a deal quality score output that takes into consideration multifactor cost estimates and learned deal data without providing a money amount of a projected profitability of a proposed vehicle sale. As a result, embodiments disclosed herein convey a sense of profitability to a sales agent more accurately than conventional approaches.

Also, in contrast to conventional approaches, some embodiments disclosed herein include a technical capability to automatically approve or reject a proposed vehicle sale without intervention from a manager (e.g., an F&I manager, a sales manager, a dealership principal, etc.). In further contrast with conventional approaches, sales agent GUIs according to embodiments disclosed herein include elements displaying automatic approval decisions (e.g., approvals and/or rejections). These improved sales agent GUIs according to some embodiments are therefore capable of conveying more information than what was conventional in the technical field.

Additionally, in contrast to conventional approaches, a manager GUI (e.g., a dealership principal GUI, an F&I manager GUI, a sales manager GUI) according to some embodiments may enable a manager (e.g., a dealership principal, an F&I manager, a sales manager) to control operation, training, and/or testing of the artificial intelligence model. Accordingly, a further technical improvement includes increased controllability of the artificial intelligence model via the manager GUI.

As is often the case with technical improvements, these, and other technical improvements of embodiments disclosed herein, result in business improvements. For example, a sales agent may not be required as often to leave a potential buyer to wait while the sales agent speaks with a manager. Also, financial and other goals of the dealership may align with sales agent compensation goals and the desires of proposed buyers through an ability to make adjustments to a proposed vehicle sale and view changes to a worker (e.g., sales agent) deal quality score, a business deal quality score, and/or an overall deal quality score in at least substantially real time. This capability may inspire creative adjustment on the part of the sales agents to more closely align with vehicle dealership goals, sales agent compensation goals, and potential buyer desires.

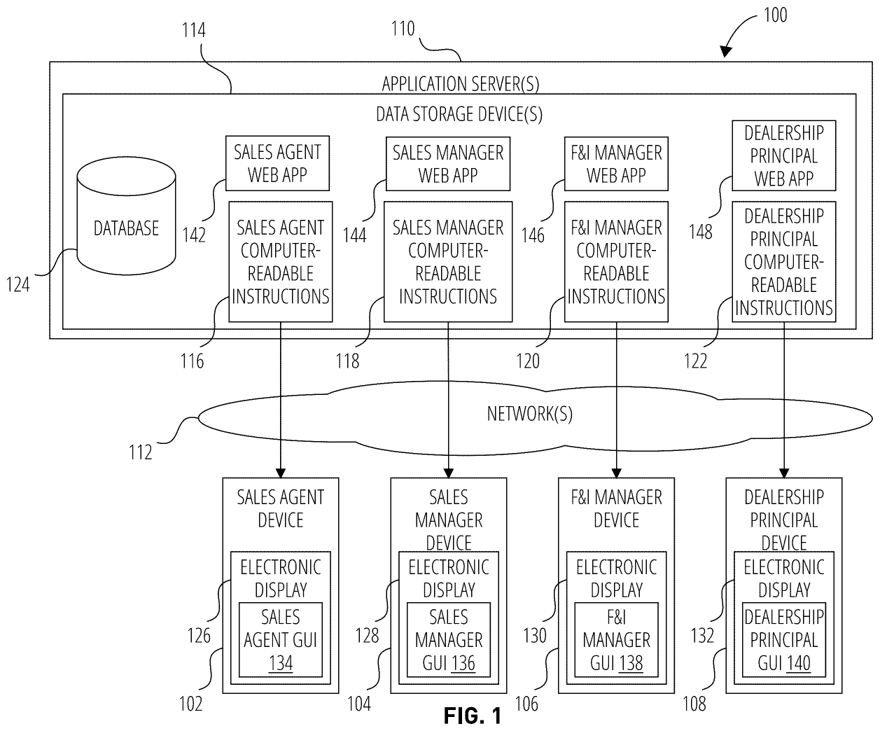

FIG. 1 is a block diagram of an example of a vehicle dealership computing system 100, according to some embodiments. The vehicle dealership computing system 100 includes one or more application servers 110 (hereinafter “application servers 110”), one or more networks 112, a sales agent device 102, a sales manager device 104, a finance and insurance manager device 106 (hereinafter “F&I manager device 106”), and a dealership principal device 108. The application servers 110 are configured to communicate with the sales agent device 102, the sales manager device 104, the F&I manager device 106, and the dealership principal device 108 via the one or more networks 112.

The application servers 110 include one or more data storage devices 114 (hereinafter “storage 114”) (e.g., one or more non-transitory computer-readable media) including a database 124 and computer-readable instructions stored thereon. The computer-readable instructions include computer-readable instructions for a sales agent web application 142, a sales manager web application 144, a F&I manager web application 146, and a dealership principal web application 148. The computer-readable instructions also include sales agent computer-readable instructions 116 for the sales agent device 102, sales manager computer-readable instructions 118 for the sales manager device 104, F&I manager computer-readable instructions 120 for the F&I manager device 106, and dealership principal computer-readable instructions 122 for the dealership principal device 108. The application servers 110 are configured to provide, via the networks 112, the sales agent computer-readable instructions 116 to the sales agent device 102, the sales manager computer-readable instructions 118 to the sales manager device 104, the F&I manager computer-readable instructions 120 to the F&I manager device 106, and the dealership principal computer-readable instructions 122 to the dealership principal device 108.

The application servers 110 are configured to execute the sales agent web application 142 and provide the sales agent computer-readable instructions 116 to the sales agent device 102 to cause the sales agent device 102 to present a sales agent graphical user interface 134 (hereinafter “sales agent GUI 134”) on an electronic display 126 of the sales agent device 102. The sales agent computer-readable instructions 116 are configured to instruct the sales agent device 102 to present the sales agent GUI 134 on the electronic display 126 in conjunction with the sales agent web application 142.

The application servers 110 are also configured to execute the sales manager web application 144 and provide the sales manager computer-readable instructions 118 to the sales manager device 104 to cause the sales manager device 104 to present a sales manager GUI 136 on an electronic display 128 of the sales manager device 104. The sales manager computer-readable instructions 118 are configured to instruct the sales manager device 104 to present the sales manager GUI 136 on the electronic display 128 in conjunction with the sales manager web application 144.

The application servers 110 are further configured to execute the F&I manager web application 146 and provide the F&I manager computer-readable instructions 120 to the F&I manager device 106 to cause the F&I manager device 106 to present a F&I manager GUI 138 on an electronic display 130 of the F&I manager device 106. The F&I manager computer-readable instructions 120 are configured to instruct the F&I manager device 106 to present the F&I manager GUI 138 on the electronic display 130 in conjunction with the F&I manager web application 146.

The application servers 110 are also configured to execute the dealership principal web application 148 and provide the dealership principal computer-readable instructions 122 to the dealership principal device 108 to cause the dealership principal device 108 to present a dealership principal GUI 140 on an electronic display 132 of the dealership principal device 108. The dealership principal computer-readable instructions 122 are configured to instruct the dealership principal device 108 to present the dealership principal GUI 140 on the electronic display 132 in conjunction with the dealership principal web application 148.

Although FIG. 1 separately shows computer readable instructions for web applications and GUIs for the various different devices (i.e., for the sales agent device 102, the sales manager device 104, the F&I manager device 106, and the dealership principal device 108), a single web app may be executed by the application servers 110 and the same set of computer readable instructions may be sent to each of the sales agent device 102, the sales manager device 104, the F&I manager device 106, and the dealership principal device 108. In such embodiments, the various different GUIs (e.g., the sales agent GUI 134, the sales manager GUI 136, the F&I manager GUI 138, and the dealership principal GUI 140) may be displayed by the sales agent device 102, the sales manager device 104, the F&I manager device 106, and the dealership principal device 108 based on login credentials associated with a sales agent account, a sales manager account, an F&I manager account, and a dealership principal account, respectively.

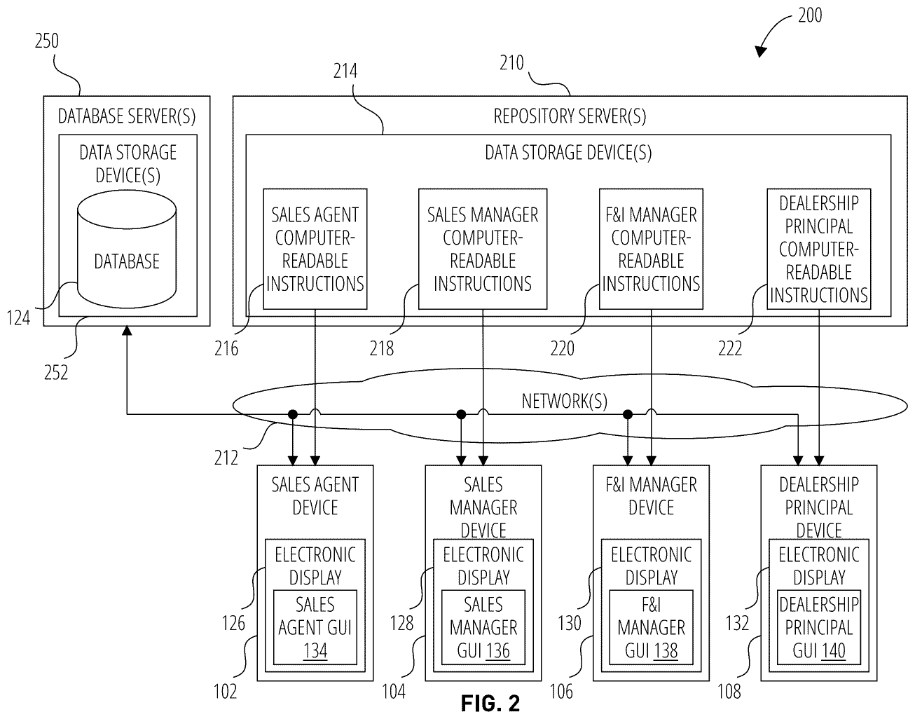

FIG. 2 is a block diagram of another example of a vehicle dealership computing system 200, according to some embodiments. The vehicle dealership computing system 200 includes one or more repository servers 210 (hereinafter “repository servers 210”), one or more database servers 250 (hereinafter “database servers 250”), and one or more networks 212. The vehicle dealership computing system 200 also includes the sales agent device 102, the sales manager device 104, the F&I manager device 106, and the dealership principal device 108 discussed with reference to FIG. 1. The repository servers 210 and the database servers 250 are configured to communicate with the sales agent device 102, the sales manager device 104, the F&I manager device 106, and the dealership principal device 108 via the one or more networks 212.

The database servers 250 include one or more data storage devices 252 (hereinafter “storage 252”) (e.g., one or more non-transitory computer-readable media) including the database 124 of FIG. 1. The repository servers 210 include one or more data storage devices 214 (hereinafter “storage 214”) computer-readable instructions stored thereon. The computer-readable instructions include computer-readable instructions for a sales agent software application (sales agent computer-readable instructions 216), a sales manager software application (sales manager computer-readable instructions 218), an F&I manager software application (F&I manager computer-readable instructions 220), and a dealership principal software application. The repository servers 210 are configured to provide, via the networks 212, the sales agent computer-readable instructions 216 to the sales agent device 102, the sales manager computer-readable instructions 218 to the sales manager device 104, the F&I manager computer-readable instructions 220 to the F&I manager device 106, and the dealership principal computer-readable instructions 222 to the dealership principal device 108.

The sales agent computer-readable instructions 216 are configured to cause the sales agent device 102 to present the sales agent GUI 134 on the electronic display 126. The sales manager computer-readable instructions 218 are configured to instruct the sales manager device 104 to present the sales manager GUI 136 on the electronic display 128. The F&I manager computer-readable instructions 220 are configured to instruct the F&I manager device 106 to present the F&I manager GUI 138 on the electronic display 130. Finally, the dealership principal computer-readable instructions 222 are configured to instruct the dealership principal device 108 to present the dealership principal GUI 140 on the electronic display 132.

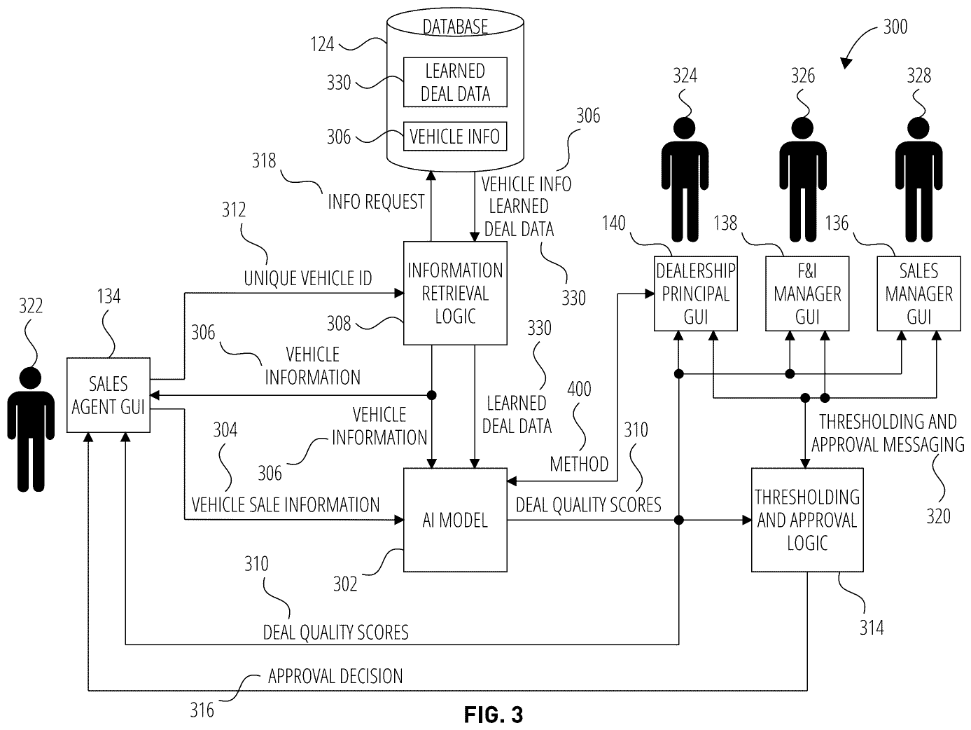

FIG. 3 is a block diagram of a deal quality score system 300, according to some embodiments. The deal quality score system 300 may be operated by the vehicle dealership computing system 100 of FIG. 1, by the vehicle dealership computing system 200 of FIG. 2, or by some other similar vehicle dealership computing system. The deal quality score system 300 includes the database 124, the sales agent GUI 134, the sales manager GUI 136, the F&I manager GUI 138, and the dealership principal GUI 140 discussed above with reference to FIG. 1 or FIG. 2. The deal quality score system 300 also includes information retrieval logic 308, an artificial intelligence model 302 (hereinafter “AI model 302”), and thresholding and approval logic 314. FIG. 3 further illustrates a sales agent 322 at the sales agent GUI 134, a dealership principal 324 at the dealership principal GUI 140, a F&I manager 326 at the F&I manager GUI 138, and a sales manager 328 at the sales manager GUI 136.

In some embodiments, the information retrieval logic 308, the AI model 302, and the thresholding and approval logic 314 may be executed by one or more of the sales agent device 102, the sales manager device 104, the F&I manager device 106, and the dealership principal device 108 (e.g., as part of the sales agent computer-readable instructions 116, the sales manager computer-readable instructions 118, the F&I manager computer-readable instructions 120, or the dealership principal computer-readable instructions 122, respectively). In some embodiments, the information retrieval logic 308, the AI model 302, and the thresholding and approval logic 314 may be executed on the server side (e.g., by the application servers 110). In some embodiments, execution of operations of the information retrieval logic 308, the AI model 302, and the thresholding and approval logic 314 may be distributed between the user side (e.g., the sales agent device 102, the sales manager device 104, the F&I manager device 106 and/or the dealership principal device 108) and the server side. Similarly, although the database 124 is shown in FIG. 1 and FIG. 2 on the server side, in some embodiments, part or all of the database 124 may instead be stored at the user side (e.g., by the sales agent device 102, the sales manager device 104, the F&I manager device 106, and/or the dealership principal device 108).

Referring to components of the vehicle dealership computing system 100 of FIG. 1 and/or to components of the vehicle dealership computing system 200 of FIG. 2 together with FIG. 3, a potential customer may approach the sales agent 322 to negotiate a vehicle sale. The sales agent GUI 134 may receive, from the sales agent 322, a unique vehicle identifier 312 (e.g., a vehicle identification number (VIN)) uniquely identifying a vehicle that a vehicle sale is being negotiated or proposed for. The sales agent device 102 executing the sales agent GUI 134 provides the unique vehicle identifier 312 to the information retrieval logic 308, which sends an information request 318 to storage 114 to access vehicle information 306 for the uniquely identified vehicle from the database 124.

The database 124 includes learned deal data 330 and vehicle information 306 for each of the vehicles the vehicle dealership is selling. The AI model 302 may use the learned deal data 330, in conjunction with the vehicle sale information 304 and multifactor estimates of costs taken from the vehicle information 306, to generate the deal quality scores 310. By way of non-limiting examples, the vehicle information 306 may include data indicating information uniquely identifying the vehicles (e.g., VINs); list prices for the vehicles; make, model, and year of the vehicles; condition (e.g., used, new, state of maintenance and/or repair, etc.) of the vehicles; specifications (e.g., mileage, color, engine type, etc.) of the vehicles, ownership history; vehicle collision history; and/or any other relevant vehicle information. The vehicle information 306 may also include, for each vehicle, data indicating multifactor estimates of costs incurred by the vehicle dealership for each vehicle (e.g., for the uniquely identified vehicle). In some embodiments, the multifactor estimates of costs incurred by the vehicle dealership for the uniquely identified vehicle include a purchase price of the uniquely identified vehicle that the vehicle dealership paid to acquire the uniquely identified vehicle. In some embodiments, the multifactor estimates of costs incurred by the vehicle dealership for the uniquely identified vehicle include interest payments made by the vehicle dealership for financing the vehicle dealership used to purchase the uniquely identified vehicle. In some embodiments, the multifactor estimates of costs incurred by the vehicle dealership include costs for maintenance and repairs performed on the vehicle. In some embodiments, the multifactor estimates of costs incurred by the vehicle dealership include costs associated with upgrades made to the uniquely identified vehicle.

In some embodiments, the multifactor estimates of costs incurred by the vehicle dealership for each uniquely identified vehicle may include operating costs of the vehicle dealership. Since vehicle sales typically generate income for paying for vehicle dealership expenses in general, the operating costs of the vehicle dealership may be apportioned out to each vehicle and factored into the profitability of a proposed vehicle sale. By way of non-limiting examples, the operating costs of the vehicle dealership may include rent or mortgage payments for facilities (e.g., sales lot property and/or buildings at the sales lot, etc.); utilities (e.g., electrical power, sewer, natural gas, water, garbage disposal, internet, etc.); cleaning and maintenance costs of facilities; vehicle dealership employee salaries, benefits, commissions, bonuses, and incentives; advertising costs; equipment costs (e.g., computers, software licenses, etc.); and other vehicle dealership operating costs. In some embodiments, the vehicle dealership operating costs apportioned to a uniquely identified vehicle may be proportional to the amount of time the uniquely identified vehicle remains unsold at the vehicle dealership. In some embodiments, an equal amount of vehicle dealership operating costs may be proportioned to each vehicle sold. In some embodiments, the vehicle dealership operating costs apportioned to a uniquely identified vehicle may be proportional to the ultimate sale price or list price of the uniquely identified vehicle.

The information retrieval logic 308 receives, from the database 124, the vehicle information 306 for the uniquely identified vehicle and provides the vehicle information 306 to the AI model 302 and to the sales agent device 102. The sales agent GUI 134 at the sales agent device 102 may present at least a portion of the vehicle information 306. The sales agent GUI 134 includes input elements (e.g., text input boxes, drop-down list and/or menus, etc.) configured to receive, from the sales agent 322 operating the sales agent device 102, vehicle sale information 304 for a proposed vehicle sale of the uniquely identified vehicle. By way of non-limiting examples, the vehicle sale information 304 may include customer information (e.g., name, address, phone number, email address, drivers license number, social security number, credit information, employment information, etc.), transaction information (e.g., sale price, trade-in value, trade-in information, discounts, payment method, financing information, insurance information, sales contract information, warranty information, and/or OEM, government, and financial incentives and rebates), and/or other information. In some embodiments, the vehicle sale information 304 includes financing information indicating financing parameters of financing to be provided by the vehicle dealership for the vehicle sale to enable the AI model 302 to factor in projected profits from the financing to the deal quality scores 310. The sales agent device 102 provides the vehicle sale information 304 received via the sales agent GUI 134 to the AI model 302.

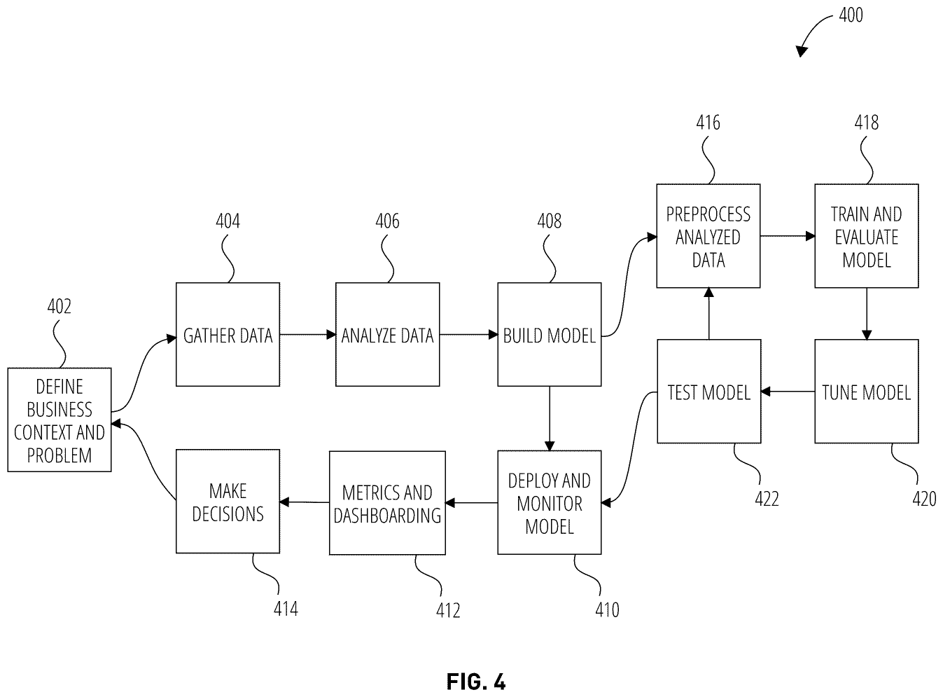

The learned deal data 330 stored in the database 124 includes historical funded deals data from multiple domains (e.g., accounting, services, F&I, etc.) of the vehicle dealership. The learned deal data 330 may be gathered, updated, and applied during the course of a method 400 of maintaining an artificial intelligence model. At least some of the method 400 may involve interaction with the dealership principal 324 via the dealership principal GUI 140, as illustrated in FIG. 3. More detail regarding method 400 is discussed below with reference to FIG. 4.

With continued reference to FIG. 3 (and also referencing components from FIG. 1 and FIG. 1), the AI model 302 receives the vehicle sale information 304, the vehicle information 306, and the learned deal data 330. The AI model 302 generates one or more deal quality scores 310 based, at least in part, on the vehicle sale information 304 and the multifactor estimates of costs (taken from the vehicle information 306) incurred by the vehicle dealership for the uniquely identified vehicle. The AI model 302 provides the deal quality scores 310 to the thresholding and approval logic 314, the sales agent device 102, the dealership principal device 108, the F&I manager device 106, and the sales manager device 104 for display by the sales agent GUI 134, the dealership principal GUI 140, the F&I manager GUI 138, and the sales manager GUI 136, respectively.

The deal quality scores 310 are free of an indication of a money value for an estimated profitability of the proposed vehicle sale. For example, each of the deal quality scores 310 may be a value that may be a score taken from a predetermined range of values (e.g., zero to one hundred). By way of non-limiting example, a higher estimated profitability of the proposed vehicle sale may generally correlate to a higher deal quality score and a lower estimated profitability may generally correlate to a lower deal quality score, all other things being equal. In such embodiments, a higher deal quality score is more desirable. As another non-limiting example, a higher estimated profitability of the proposed vehicle sale may instead generally correlate to a lower deal quality score and a lower estimated profitability may generally correlate to a higher deal quality score, in which case a lower deal quality score is generally desirable.

Other factors that do not relate directly to profitability of the proposed vehicle sale may also be considered by the AI model 302 in generating the deal quality scores 310. By way of non-limiting example, the dealership principal 324 may determine that trade-ins are not desirable in vehicle sales. In this example, deal quality scores 310 for proposed vehicle sales that involve a vehicle trade-in may generally be lower than proposed vehicle sales that do not involve a vehicle trade-in, all other things being equal. As another non-limiting example, the dealership principal 324 may determine to promote electric vehicle and hybrid vehicle sales over gasoline vehicle sales. In this example, deal quality scores 310 for proposed vehicle sales involving electric vehicles and hybrid vehicles may generally be higher than deal quality scores 310 for proposed vehicle sales involving gasoline vehicles. Interactions between the dealership principal GUI 140 and the AI model 302 may be coordinated through method 400, which is discussed with reference to FIG. 4.

Some of the deal quality scores 310 may be role based consistent with the concept that a given vehicle sale may reflect different strengths and weaknesses of those in the different roles. For example, each role (e.g., sales agent 322, dealership principal 324, F&I manager 326, and sales manager 328) within the vehicle dealership may have its own worker score (e.g., the worker score 702 of FIG. 7, which may be, e.g., a sales agent score) of the deal quality scores 310 associated therewith. For example, a worker score may be generated based, at least in part, on parameters set by business metrics. Generating a worker score may take into consideration each sale by the worker and measure a profitability of the sale against business goals and net gross profit needed for each vehicle sale. Generating a worker score may take into consideration trade-in allowance, sales price, and products and insurance sold as part of the vehicle sale in relation to the vehicle actual cost (e.g., taking into consideration adjustments such as repair orders), and add-ons, interest paid for the vehicle, and other profitability considerations. Worker scores may be aggregated, compared, and ranked with some or all workers for a vehicle dealership. The worker scores may be used by vehicle dealerships to provide perks, incentives, and other employee rewards.

The deal quality scores 310 may also include a business score (e.g., the business score 602 of FIG. 6) to indicate how good or bad vehicle sales are for the vehicle dealership from a business perspective (e.g., profitability and other business goals). By way of non-limiting example, the business score may be a simple number highlighting the level of profitability for a specific department (e.g., sales, service, parts, etc.) of the dealership. By way of non-limiting example, the business score for a sales department may be calculated based on the gross profit and net profit for vehicle sales and/or how effective the workforce in the sales department is (e.g., determined based on some aggregation of worker scores of workers in the department). A similar aggregation of worker scores may be used for other departments of a vehicle dealership to determine a business score for those other departments.

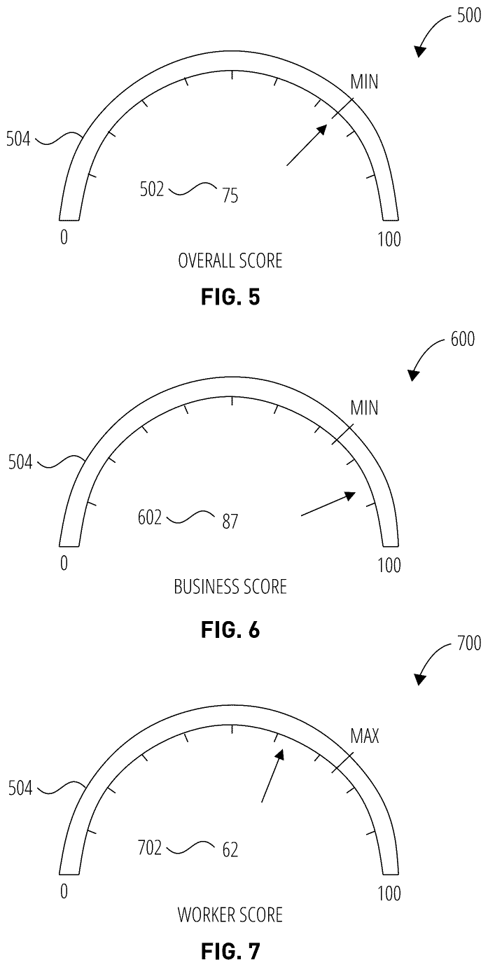

The deal quality scores 310 may further include an overall or composite score (e.g., the overall score 502 of FIG. 5) to indicate an overall score for the vehicle dealership. By way of non-limiting example, an overall score may reflect strengths and weaknesses indicated by the various worker scores and the business score. As a specific non-limiting example, the overall score may be an arithmetic mean, a median, or some other mathematical combination of the others of the deal quality scores 310. As another specific, non-limiting example, the overall score may be determined using a weighted computation based on business scores from various departments of the vehicle dealership according to rules created and/or set by the vehicle dealership (e.g., by the dealership principal). As a result, one vehicle dealership may use a different computation to determine its own overall score as compared to another computation used by another vehicle dealership to determine its overall score. In this way, each individual vehicle dealership may customize how its own overall score is determined to enable the vehicle dealership to assess its success according to its own goals and rules.

The sales agent GUI 134 is configured to display at least one of the deal quality scores 310 for the proposed vehicle sale. By way of non-limiting example, the sales agent GUI 134 may display a worker score specific to the sales agent 322 (e.g., a sales agent deal quality score) to inform the sales agent 322 as to the strength of the sale to his or her performance as a sales agent. The sales agent GUI 134 may also display a business score and an overall score to inform the sales agent 322 as to the strength of the sale from a business perspective and an overall perspective. The sales agent GUI 134 may further display an overall score to inform the sales agent 322 as to the strength of the sale from an overall perspective.

The sales agent GUI 134 is also configured to display an approval decision 316 indicating whether the proposed vehicle sale is approved by the vehicle dealership based, at least in part, on the deal quality scores 310 and one or more deal quality score threshold values. For example, deal quality score threshold values defining ranges of the deal quality scores 310 corresponding to automatic approvals may be set by the sales manager 328 via the sales manager GUI 136, the F&I manager 326 via the F&I manager GUI 138, and/or by a dealership principal 324 via the dealership principal GUI 140. As a specific, non-limiting example, a vehicle sale may be approved (e.g., automatically) if a worker score for a sales agent is within pre-defined ranges defined by the deal quality score threshold values. Thresholding and approval messaging 320 between the thresholding and approval logic 314 and the dealership principal GUI 140, the F&I manager GUI 138, and/or the sales manager GUI 136 may be used to coordinate and set the deal quality score threshold values. Accordingly, the approval decision 316 displayed by the sales agent GUI 134 may indicate that the proposed sale is approved, and the proposed sale may proceed to completion without intervention from the dealership principal 324, the F&I manager 326, or the sales manager 328 as long as the deal quality scores 310 fall within automatic approval ranges.

Also by way of non-limiting example, deal quality score threshold values defining ranges of the deal quality scores 310 corresponding to automatic rejections may be set by the sales manager 328 via the sales manager GUI 136, the F&I manager 326 via the F&I manager GUI 138, and/or by a dealership principal 324 via the dealership principal GUI 140. Again, thresholding and approval messaging 320 between the thresholding and approval logic 314 and the dealership principal GUI 140, the F&I manager GUI 138, and/or the sales manager GUI 136 may be used to coordinate and set the threshold values. As a result, the approval decision 316 displayed by the sales agent GUI 134 may indicate that the proposed sale is rejected without intervention from the dealership principal 324, the F&I manager 326, or the sales manager 328.

As a further non-limiting example, deal quality score threshold values defining ranges of the deal quality scores 310 corresponding to manual approval/rejection may be set by the sales manager 328 via the sales manager GUI 136, the F&I manager 326 via the F&I manager GUI 138, and/or by a dealership principal 324 via the dealership principal GUI 140. As discussed above, thresholding and approval messaging 320 may be used to coordinate and set the threshold values. The thresholding and approval messaging 320 may also be used to send approval inquiries to the dealership principal 324, the F&I manager 326, and/or the sales manager 328 to be presented by the dealership principal GUI 140, the F&I manager GUI 138, and/or the sales manager GUI 136, respectively. The thresholding and approval logic 314 may receive, via the thresholding and approval messaging 320, manually provided approvals/rejections from the dealership principal GUI 140, the F&I manager GUI 138, and/or the sales manager GUI 136 (e.g., provided by one or more of the dealership principal 324, the F&I manager 326, and the sales manager 328 may be required to approve/reject the proposed vehicle sale) and provide the corresponding approval decision 316 to the sales agent GUI 134.

As a specific, non-limiting example, deal quality score thresholds may divide the range of possible deal quality scores 310 into one or more automatic approval ranges, one or more automatic rejection ranges, and one or more manual approval ranges. An automatic approval range may be defined by a minimum automatic approval threshold value and a maximum automatic approval threshold value. The minimum automatic approval threshold value may, at least in part, correspond to a minimum allowable profitability. The maximum automatic approval threshold value may be set to prevent overpricing of vehicles. The automatic rejection ranges may be defined by an automatic rejection threshold value, and deal quality scores below the automatic rejection threshold value may fall within the automatic rejection ranges. A manual approval range may be between the automatic rejection threshold value and the minimum automatic approval threshold value. Deal quality scores above the maximum automatic approval threshold value may be part of the automatic rejection range or the manual approval range depending on preferences set (e.g., by the dealership principal 324, the F&I manager 326, or the sales manager 328) via the thresholding and approval messaging 320. By way of non-limiting example, automatic approvals may be made only where all of the deal quality scores 310 are in their respective automatic approval ranges. Also by way of non-limiting example, automatic rejections may be made where even just one of the deal quality scores 310 is within its respective automatic rejection range.

Regardless of the deal quality scores 310 and the approval decision 316 displayed by the sales agent GUI 134, the sales agent 322 may manipulate the vehicle sale information 304 via the sales agent GUI 134 to fine tune the deal quality scores 310 and/or the approval decision 316 to obtain, in at least substantially real-time, desired deal quality scores 310 and/or a desired approval decision 316. This may give the sales agent 322 the freedom to work with a potential vehicle buyer to set one or more non-negotiable buyer-desired parameters of the vehicle sale information 304 (e.g., a certain desired monthly payment, a particular interest rate, etc.) and make adjustments to other parameters of the vehicle sale information 304 until the deal quality scores 310 fall into desired/acceptable ranges.

The vehicle dealership may also assess performance of sales agents such as sales agent 322 based at least in part on deal quality scores 310 corresponding to sales completed by the sales agent 322 over periods of time. Also, decisions for rewards such as bonuses, commissions, or other employee benefits may be made based, at least in part, on the deal quality scores 310 (e.g., over a period of time). By way of non-limiting example, a higher percent commission may be awarded to the sales agent 322 for a higher deal quality score corresponding to a vehicle sale. As another non-limiting example, a higher periodic bonus may be awarded to the sales agent 322 for a higher average deal quality score over a period of time. These types of incentives enable the sales agent 322 to use the sales agent GUI 134 to fine tune the vehicle sale information 304 for proposed vehicle sales to increase rewards provided to the sales agent 322 for vehicle sales. If the AI model 302 is properly trained to maximize the vehicle dealership's profitability and achieve other business goals, the sales agent GUI 134 may not only enable the sales agent 322 to increase rewards and bonuses, but this increase in rewards and bonuses to the sales agent 322 may also increase profitability for the vehicle dealership and push the vehicle dealership toward accomplishing its business goals.

One or more of the dealership principal GUI 140, the F&I manager GUI 138, or the sales manager GUI 136 may include input elements configured to receive vehicle dealership guidelines defining how the deal quality score is determined and the one or more deal quality threshold values to classify the deal quality score into a plurality of deal quality levels. In some embodiments, the plurality of deal quality levels includes an automatic approval level (e.g., corresponding to one or more automatic approval ranges for the deal quality scores 310), an automatic rejection level (e.g., corresponding to one or more automatic rejection ranges for the deal quality scores 310), and a manual approval level (e.g., corresponding to one or more manual approval ranges for the deal quality scores 310).

By way of non-limiting example, a vehicle dealership computing system (e.g., the vehicle dealership computing system 100 of FIG. 1 or the vehicle dealership computing system 200 of FIG. 2) may include a vehicle dealership manager device (e.g., the sales manager device 104, the F&I manager device 106, or the dealership principal device 108) configured to present a vehicle dealership manager GUI (e.g., the sales manager GUI 136, the F&I manager GUI 138, or the dealership principal GUI 140) configured to enable a vehicle dealership manager (e.g., the sales manager 328, the dealership principal 324, or the F&I manager 326) operating the vehicle dealership manager device to control parameters for training an artificial intelligence model (e.g., via method 400 of FIG. 4) to generate the deal quality scores 310. The sales agent device 102 is configured to present the sales agent GUI 134, which includes input elements configured to receive, from a user (e.g., the sales agent 322) operating the sales agent device 102, the vehicle sale information 304 for a proposed vehicle sale of a uniquely identified vehicle. The sales agent GUI 134 is also configured to display a deal quality score (e.g., one or more of the deal quality scores 310) for the proposed vehicle sale. The deal quality score is generated by the AI model 302 based, at least in part, on the vehicle sale information 304 and multifactor estimates of costs incurred by a vehicle dealership for the uniquely identified vehicle (e.g., taken from the vehicle information 306). The deal quality score is free of an indication of a money value for an estimated profitability of the proposed vehicle sale. The sales agent device 102 is also configured to display the approval decision 316 indicating whether the vehicle sale is approved by the vehicle dealership based, at least in part, on the deal quality score and one or more deal quality score threshold values. In some embodiments, the vehicle dealership manager GUI is configured to enable the vehicle dealership manager to set the one or more deal quality score threshold values (e.g., via thresholding and approval messaging 320). In some embodiments, the one or more deal quality score threshold values define an automatic approval range of values for the deal quality score and the approval decision 316 displayed by the sales agent device automatically indicates that the vehicle sale is approved responsive to a determination that the deal quality score is within the approval range of values. In some embodiments, the one or more deal quality score threshold values define an automatic rejection range of values for the deal quality score. In some embodiments, the approval decision 316 displayed by the sales agent device 102 automatically indicates that the vehicle sale is rejected responsive to a determination that the deal quality score is within the automatic rejection range of values. In some embodiments, the one or more deal quality score threshold values include a minimum limit below which the deal quality score triggers an automatic rejection. In some embodiments, the one or more deal quality score threshold values define a manual approval range of values for the deal quality score and the vehicle dealership manager GUI is configured to prompt the vehicle dealership manager for a manual approval or rejection of the proposed vehicle sale responsive to the deal quality score falling within the manual approval range of values. The approval decision 316 is displayed by the sales agent device indicating the manual approval or rejection received with the vehicle dealership manager GUI.

FIG. 4 is a flowchart illustrating a method 400 of maintaining an artificial intelligence model (e.g., the AI model 302 of FIG. 3) that generates deal quality scores (e.g., the deal quality scores 310 of FIG. 3), according to some embodiments. At operation 402, the method 400 includes defining a business context and problem to be solved by the artificial intelligence model. In some embodiments, defining the business context and problem to be solved may be performed on one or more of the dealership principal GUI 140 (e.g., responsive to inputs provided by the dealership principal 324), the F&I manager GUI 138 (e.g., responsive to inputs provided by the F&I manager 326), the sales manager GUI 136 (e.g., responsive to inputs provided by the sales manager 328 of FIG. 3).

In some embodiments, defining the business context and problem to be solved (operation 402) may include identifying parameters/factors that will be taken into consideration by the artificial intelligence model in determining the deal quality scores. For example, a GUI (e.g., the dealership principal GUI 140, the F&I manager GUI 138, the sales manager GUI 136 of FIG. 1 and/or FIG. 2), may present, to a user (e.g., the dealership principal 324, the F&I manager 326, and/or the sales manager 328 of FIG. 3), user-selectable parameters/factors or other input elements to receive a selection of which profitability parameters/factors may be taken into account in determining the deal quality scores. By way of non-limiting example, the parameters/factors that will be taken into consideration by the artificial intelligence model may include profitability factors (e.g., factors contributing to a determined profitability of a proposed/completed sale). These profitability factors may include multifactor cost estimates such as purchase price, interest payments made by the vehicle dealership, costs for maintenance and repairs, costs associated with upgrades, dealership operating costs, etc. ; and other profitability information such as projected interest profits for financing, other financing information, rebate information, government incentive information, etc.

In some embodiments, defining the business context and problem to be solved (operation 402) may include correlating priorities to identified parameters/factors that will be taken into consideration by the artificial intelligence model in determining the deal quality scores. For example, a GUI (e.g., the dealership principal GUI 140, the F&I manager GUI 138, the sales manager GUI 136), may present, to a user (e.g., the dealership principal 324, the F&I manager 326, and/or the sales manager 328), user-selectable factors or other input elements to receive a selection of priorities of the selected parameters/factors. By way of non-limiting example, the GUI may enable the user to generate an ordered list of the identified parameters/factors from highest priority to lowest priority. Also by way of non-limiting example, the GUI may enable the user to assign a priority score (e.g., on a scale from one to five or from one to ten) indicating a priority of the each identified parameter/factor. In such embodiments, the artificial intelligence model may assign a heavier weight to higher rated parameters/factors and a lower weight to lower rated parameters/factors.

In some embodiments, defining the business context and problem to be solved (operation 402) may include identifying parameters/factors that are not directly related to profitability to be taken into consideration by the artificial intelligence model in determining the deal quality scores. By way of non-limiting example, a decision maker at the vehicle dealership (e.g., the dealership principal 324, the F&I manager 326, the sales manager 328) may elect to award higher deal quality scores to proposed and completed vehicle sales that involve hybrid or electric vehicles in order to incentivize a push toward selling more hybrid or electric vehicles. Also by way of non-limiting example, the decision maker may elect to award higher deal quality scores to proposed and completed vehicle sales that involve sales of vehicles of a particular make and/or model of vehicle (e.g., a decision maker at a vehicle dealership of a particular make of vehicle may wish to incentivize sales of that particular make of vehicle).

In some embodiments, defining the business context and problem to be solved (operation 402) may include setting deal quality score threshold values. As discussed with reference to FIG. 3, the dealership principal GUI 140, the F&I manager GUI 138, and/or the sales manager GUI 136 may be configured to enable the dealership principal 324, the F&I manager 326, and/or the sales manager 328 to set the deal quality score threshold values.

At operation 404, the method 400 includes gathering data for building the artificial intelligence model. In some embodiments, gathering the data for building the artificial intelligence model may include accessing historic vehicle sale information (e.g., from the database 124 of FIG. 1, FIG. 2, and FIG. 3). The historic vehicle sale information may include vehicle information and vehicle sale information for past vehicle sales.

At operation 406, the method 400 includes analyzing the data (e.g., the data gathered at operation 404). In some embodiments, analyzing the data includes a GUI (e.g., the dealership principal GUI 140, the F&I manager GUI 138, and/or the sales manager GUI 136) presenting information for past individual vehicle sales and presenting input elements configured to enable the user (e.g., the dealership principal 324, the F&I manager 326, and/or the sales manager 328, respectively) to identify strengths and/or weaknesses of the past individual vehicle sales. In some embodiments, analyzing the data includes presenting vehicle information and vehicle sales information for vehicle sales from the historic vehicle sale information and receiving, via a GUI (e.g., the dealership principal GUI 140, the F&I manager GUI 138, and/or the sales manager GUI 136) from a user (e.g., the dealership principal 324, the F&I manager 326, and/or the sales manager 328) user-provided deal quality scores for the historic vehicle sales information.

At operation 408, the method 400 includes building the artificial intelligence model. In some embodiments, building the artificial intelligence model may include operations 416, 418, 420, and 422. Operation 416 may include preprocessing the analyzed data (e.g., the historic vehicle sale information analyzed at operation 406 and the corresponding inputs received at operation 406). In some embodiments, preprocessing the analyzed data includes unifying a format of the analyzed data from operation 406. As an example, the format of the data for the various historic vehicles may differ from one historic vehicle sale to another, and the format of that data may be adjusted to unify the format to place the data from each historic vehicle sale into the same form (e.g., delimiting the various common pieces of data for each historic vehicle sale into a common order). In some embodiments, preprocessing the analyzed data includes separating the analyzed data into a training subset of data and testing subset of analyzed data (e.g., by randomly assigning vehicle sales of the historic vehicle sale data into the training and testing subsets).

The training subset of the analyzed data may be used at operation 418 to train and evaluate the artificial intelligence model. By way of non-liming example, training and evaluating the artificial intelligence model (operation 418) may include training the artificial intelligence model based on the user-provided deal quality scores that were provided at operation 406 for the training subset of analyzed data. This training may also be based on the parameters/factors and priorities defined at operation 402. Accordingly, the artificial intelligence model may be trained to assign deal quality scores in a manner similar to that used for assigning the user-provided deal quality scores for past vehicle sales corresponding to the historic vehicle sales information at operation 406 while prioritizing parameters/factors in the manner set forth in operation 402 (defining the business context and problem).

At operation 420, the method 400 includes tuning the artificial intelligence model. For example, it may become apparent during training and evaluating the artificial intelligence model (operation 418) that the manually assigned deal quality scores at the data analysis stage (operation 406) were not strongly correlated with the highest priority parameters/factors identified at the stage of defining the business context and problem (operation 402). Accordingly, training and evaluating the artificial intelligence model may include adjusting the manually assigned deal quality scores from the data analysis stage (operation 406) and/or adjusting the parameter/factor priorities to fine-tune the artificial intelligence model.

At operation 422, the method 400 includes testing the trained/tuned artificial intelligence model. By way of non-limiting example, the test subset of the analyzed data (from operation 406) may be input to the artificial intelligence model to determine whether the resulting deal quality scores assigned to the historic vehicle sales by the artificial intelligence model are close to those manually assigned at operation 406.

At operation 410, the method 400 includes deploying and monitoring the trained, tuned, and tested artificial intelligence model. For example, deploying and monitoring the artificial intelligence model may include deploying the artificial intelligence model into the deal quality score system 300 (i.e., as the AI model 302) discussed with reference to FIG. 3 to determine deal quality scores 310 for proposed vehicle sales. Deploying and monitoring the artificial intelligence model may include providing vehicle sale information, learned deal data, and vehicle information for a proposed or completed vehicle sale to the artificial intelligence model to determine one or more deal quality scores.

At operation 412, the method 400 includes performing metrics and dashboarding operations. By way of non-limiting examples, metrics that may be checked include one or more of accuracy (e.g., a ratio of correctly predicted instances to total instances), precision (e.g., a ratio of true positive predictions to the total predicted positives), recall (e.g., the ratio of true positive predictions to actual positives), an F1 score (e.g., a harmonic mean of precision and recall), an area under the receiver operating characteristic curve (AUC-ROC), mean square error (MSE), mean absolute error (MAE), a confusion matrix, log loss, etc. Components of the dashboarding may include one or more of visualizations (e.g., charts, graphs, etc.), alerts/notifications, comparative analysis to compare different models or version of the model, etc. The metrics and dashboarding may be used to determine whether the artificial intelligence model is performing correctly, whether the prioritization of parameters/factors performed at operation 402 is being properly implemented.

At operation 414, the method 400 includes making decisions. In some embodiments, making decisions includes making automatic decisions to approve or reject proposed vehicle sales based on deal quality scores generated by the artificial intelligence model.

Changes to the execution of the operations of the method 400 may be made, and the artificial intelligence model may be trained, tested, adjusted, and redeployed as new information is acquired through operation of the artificial intelligence model.

FIG. 5 is an example of an overall score meter 500, according to some embodiments.

FIG. 6 is an example of a business score meter 600, according to some embodiments.

FIG. 7 is an example of a worker score meter 700, according to some embodiments. Referring to FIG. 5, FIG. 6, and FIG. 7 together, a sales agent GUI 134 (FIG. 3) may be configured to display the overall score meter 500, the business score meter 600, and the worker score meter 700 responsive to receiving deal quality scores 310 (FIG. 3). The overall score meter 500, the business score meter 600, and the worker score meter 700 provide visually informative information to communicate the deal quality scores 310 and relevant deal quality threshold values to the sales agent 322 (FIG. 3). Specifically, the overall score meter 500, the business score meter 600, and the worker score meter 700 illustrate an overall score 502, a business score 602, and a worker score 702, respectively.

Each of the overall score meter 500, the business score meter 600, and the worker score meter 700 includes an arch 504 extending from a minimum deal quality score (e.g., 0 in this case) to a maximum deal quality score (e.g., 100 in this case). Accordingly, the arch 504 extends across a range of possible values for the deal quality score. In some embodiments, the arch 504 may be filled with color to indicate an acceptability of the deal quality score across the range. By way of non-limiting example, an end of the arch 504 at the minimum deal quality score may be filled with the color red and the color may change along a length of the arch 504 from red to orange to yellow and finally to green at an end of the arch 504 at the maximum deal quality score. In some embodiments, different colors along the arch 504 may correlate with different ones of an automatic approval range, an automatic rejection range, and a manual approval range of the deal quality scores. As a specific, non-limiting example, a red area of the arch 504 may correspond to an automatic rejection range, a yellow area of the arch 504 may correspond to a manual approval range, and a green area of the arch 504 may correspond to an automatic approval range.

Each of the overall score meter 500, the business score meter 600, and the worker score meter 700 also includes an arrow pointing to a point along the arch 504 corresponding to the displayed deal quality score. For example, the arrow of overall score meter 500 points to 75 along the arch 504, corresponding to the overall score 502, which is 75 in the illustrated example. Also, the arrow of business score meter 600 points to 87 along the arch 504, corresponding to the business score 602, which is 87 in the illustrated example. Finally, the arrow of worker score meter 700 points to 62, corresponding to the worker score 702, which is 62 in the illustrated example.

The overall score meter 500 illustrates a minimum overall deal quality score of 75 in this example. Accordingly, the overall score 502 of 75 is at the minimum overall deal quality score in this example (illustrated as “MIN” in FIG. 5). In some embodiments, the minimum overall deal quality score may be a bottom limit above which automatic approvals may be granted. In some embodiments, the minimum overall deal quality score may be a bottom limit above which manual approvals may be provided, and below which automatic rejections are provided.

The business score meter 600 illustrates a minimum business deal quality score of 75 in this example (illustrated as “MIN” in FIG. 6). In some embodiments, the minimum business deal quality score may be a bottom limit above which automatic approvals may be granted. In some embodiments, the minimum business deal quality score may be a bottom limit above which manual approvals may be provided, and below which automatic rejections are provided.

The worker score meter 700 illustrates a maximum worker deal quality score of 62 in this example (illustrated as “MAX” in FIG. 7). In some embodiments, the maximum business deal quality score may be a top limit above which automatic approvals may not be granted. In some embodiments, the maximum worker deal quality score may be a top limit above which manual approvals may not be provided.

By way of non-limiting example, an automatic approval of a proposed vehicle sale may not be provided unless all of the illustrated deal quality scores (the overall score 502, the business score 602, and the worker score 702) are within the limits illustrated by the arrows of the overall score meter 500, the business score meter 600, and the worker score meter 700 (e.g., above “MIN” in FIG. 5, above “MIN” in FIG. 6, and below “MAX” in FIG. 7). Also by way of non-limiting example, a manual approval of a proposed vehicle sale may not be permitted unless all of the illustrated deal quality scores are within the limits illustrated by the arrows of the overall score meter 500, the business score meter 600, and the worker score meter 700.

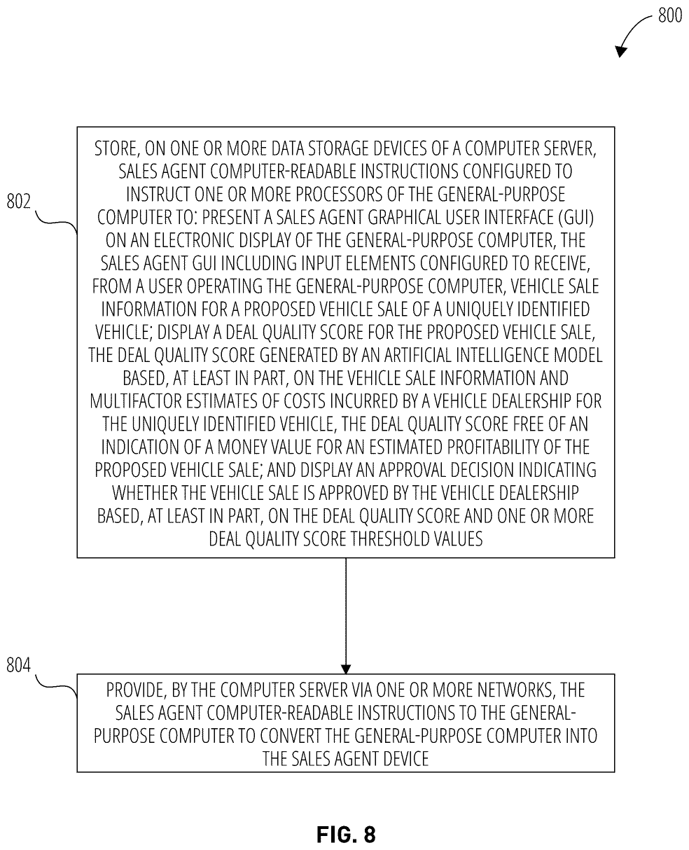

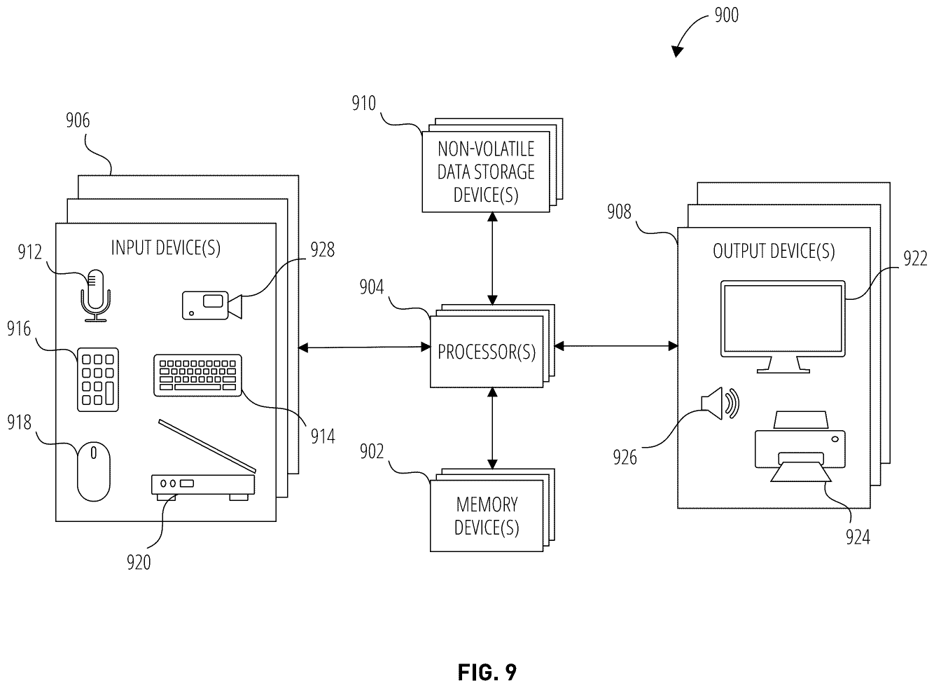

FIG. 8 is a flowchart illustrating a method 800 of converting a general-purpose computer into a sales agent device (e.g., the sales agent device 102 of FIG. 1 or the sales agent device 202 of FIG. 2), according to some embodiments. At operation 802 the method 800 includes storing, on one or more data storage devices (e.g., storage 114 of FIG. 1 or storage 214 of FIG. 2) of a computer server (e.g., application servers 110 of FIG. 1 or repository servers 210 of FIG. 2), sales agent computer-readable instructions (e.g., sales agent computer-readable instructions 116 of FIG. 1 or sales agent computer-readable instructions 216 of FIG. 2) configured to instruct one or more processors (e.g., processors 904 of FIG. 9) of the general-purpose computer to: present a sales agent graphical user interface (GUI) (e.g., the sales agent GUI 134 of FIG. 1, FIG. 2, and FIG. 3) on an electronic display (e.g., electronic display 126 of FIG. 1 or FIG. 2) of the general-purpose computer. The sales agent GUI includes input elements configured to receive, from a user (e.g., sales agent 322 of FIG. 2) operating the general-purpose computer, vehicle sale information (e.g., vehicle sale information 304 of FIG. 3) for a proposed vehicle sale of a uniquely identified vehicle. The sales agent computer-readable instructions are also configured to instruct the one or more processors of the general-purpose computer to display a deal quality score (e.g., one or more of the deal quality scores 310 of FIG. 3, the overall score 502 of FIG. 5, the business score 602 of FIG. 6, or the worker score 702 of FIG. 7) for the proposed vehicle sale, the deal quality score generated by an artificial intelligence model (e.g., the AI model 302 of FIG. 3) based, at least in part, on the vehicle sale information and multifactor estimates of costs incurred by a vehicle dealership for the uniquely identified vehicle, the deal quality score free of an indication of a money value for an estimated profitability of the proposed vehicle sale. The sales agent computer-readable instructions are further configured to instruct the one or more processors of the general-purpose computer to display an approval decision indicating whether the vehicle sale is approved by the vehicle dealership based, at least in part, on the deal quality score and one or more deal quality score threshold values.

At operation 804, the method 800 includes providing, by the computer server via one or more networks (e.g., the networks 112 of FIG. 1 or the networks 212 of FIG. 2), the sales agent computer-readable instructions to the general-purpose computer to convert the general-purpose computer into the sales agent device.

FIG. 9 is a block diagram of a computing system 900, according to some embodiments. The computing system 900 includes one or more processors 904 operably coupled to one or more memory devices 902, one or more non-volatile data storage devices 910, one or more input devices 906, and one or more output devices 908. In some embodiments the computing system 900 includes a personal computer (PC) such as a desktop computer, a laptop computer, a tablet computer, a mobile computer (e.g., a smartphone, a personal digital assistant (PDA), etc.), a network server, or other computer device.

The computing system 900 may be a general-purpose computer that may be converted into a special-purpose computer responsive to computer-readable instructions according to various embodiments discussed herein. For example, the sales agent computer-readable instructions 116 of FIG. 1 or the sales agent computer-readable instructions 216 of FIG. 2 may convert the computing system 900 into a sales agent device 102 according to various embodiments. As another example, the sales manager computer-readable instructions 118 of FIG. 1 or the sales manager computer-readable instructions 218 of FIG. 2 may convert the computing system 900 into a sales manager device 104 according to various embodiments. As yet another example, the F&I manager computer-readable instructions 120 of FIG. 1 or the F&I manager computer-readable instructions 220 of FIG. 2 may convert the computing system 900 into a F&I manager device 106 according to various embodiments. As a further example, the dealership principal computer-readable instructions 122 of FIG. 1 or the dealership principal computer-readable instructions 222 of FIG. 2 may convert the computing system 900 into a dealership principal device 108 according to various embodiments.

In some embodiments the one or more processors 904 may include a central processing unit (CPU) or other processor configured to control the computing system 900. In some embodiments the one or more memory devices 902 include random access memory (RAM), such as volatile data storage (e.g., dynamic RAM (DRAM) static RAM (SRAM), etc.). In some embodiments the one or more non-volatile data storage devices 910 include a hard drive, a solid state drive, Flash memory, erasable programmable read only memory (EPROM), other non-volatile data storage devices, or any combination thereof. In some embodiments the one or more input devices 906 include a keyboard 914, a pointing device 918 (e.g., a mouse, a track pad, etc.), a microphone 912, a keypad 916, a scanner 920, a camera 928, other input devices, or any combination thereof. In some embodiments the output devices 908 include an electronic display 922, a speaker 926, a printer 924, other output devices, or any combination thereof.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,”etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc. ” or “one or more of A, B, and C, etc. ” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A non-transitory computer-readable medium of a computer server, the non-transitory computer-readable medium including sales agent computer-readable instructions stored thereon, the sales agent computer-readable instructions configured to instruct a sales agent device to:
present a sales agent graphical user interface (GUI) on an electronic display of the sales agent device, the sales agent GUI including input elements configured to receive, from a user operating the sales agent device, vehicle sale information for a proposed vehicle sale of a uniquely identified vehicle;
display a deal quality score for the proposed vehicle sale, the deal quality score generated by an artificial intelligence model based, at least in part, on the vehicle sale information and multifactor estimates of costs incurred by a vehicle dealership for the uniquely identified vehicle, the deal quality score free of an indication of a money value for an estimated profitability of the proposed vehicle sale; and
display an approval decision indicating whether the vehicle sale is approved by the vehicle dealership based, at least in part, on the deal quality score and one or more deal quality score threshold values.

2. The non-transitory computer-readable medium of claim 1, wherein the computer server is an application server configured to execute a sales agent web application and provide the sales agent computer-readable instructions to the sales agent device to cause the sales agent device to present the sales agent GUI on the electronic display of the sales agent device.

3. The non-transitory computer-readable medium of claim 1, wherein the computer server is a repository server configured to provide the sales agent computer-readable instructions to the sales agent device, the sales agent computer-readable instructions comprising executable code of a sales agent software application configured to cause the sales agent device to present the sales agent GUI on the electronic display.

4. The non-transitory computer-readable medium of claim 1, wherein the vehicle sale information includes financing information indicating financing parameters of financing to be provided by the vehicle dealership for the vehicle sale to enable the artificial intelligence model to factor in projected profits from the financing to the deal quality score.

5. The non-transitory computer-readable medium of claim 1, wherein the multifactor estimates of costs incurred by the vehicle dealership for the uniquely identified vehicle include interest payments for financing the vehicle dealership used to purchase the uniquely identified vehicle.

6. The non-transitory computer-readable medium of claim 1, further comprising dealership principal computer-readable instructions to instruct a dealership principal device to present a dealership principal GUI.

7. The non-transitory computer-readable medium of claim 6, wherein the dealership principal GUI includes input elements configured to receive vehicle dealership guidelines defining how the deal quality score is determined and one or more deal quality threshold values to classify the deal quality score into a plurality of deal quality levels.

8. The non-transitory computer-readable medium of claim 7, wherein the plurality of deal quality levels includes an automatic approval level.

9. The non-transitory computer-readable medium of claim 1, wherein the sales agent computer-readable instructions are configured to instruct the sales agent device to display a plurality of deal quality scores including the deal quality score, the plurality of deal quality scores including a business deal quality score, a worker deal quality score, and an overall deal quality score.

10. The non-transitory computer-readable medium of claim 9, wherein the overall deal quality score is determined as a function of the business deal quality score and the worker deal quality score.

11. The non-transitory computer-readable medium of claim 9, wherein the sales agent GUI includes an overall score meter to display the overall deal quality score, a business score meter to display the business deal quality score, and a worker meter to display the worker deal quality score.

12. A method of converting a general-purpose computer into a sales agent device, the method comprising:
storing, on one or more data storage devices of a computer server, sales agent computer-readable instructions configured to instruct one or more processors of the general-purpose computer to:
present a sales agent graphical user interface (GUI) on an electronic display of the general-purpose computer, the sales agent GUI including input elements configured to receive, from a user operating the general-purpose computer, vehicle sale information for a proposed vehicle sale of a uniquely identified vehicle;
display a deal quality score for the proposed vehicle sale, the deal quality score generated by an artificial intelligence model based, at least in part, on the vehicle sale information and multifactor estimates of costs incurred by a vehicle dealership for the uniquely identified vehicle, the deal quality score free of an indication of a money value for an estimated profitability of the proposed vehicle sale; and
display an approval decision indicating whether the vehicle sale is approved by the vehicle dealership based, at least in part, on the deal quality score and one or more deal quality score threshold values; and
providing, by the computer server via one or more networks, the sales agent computer-readable instructions to the general-purpose computer to convert the general-purpose computer into the sales agent device.

13. The method of claim 12, wherein providing the sales agent computer-readable instructions to the general-purpose computer comprises providing, by an application server, a web application to the general-purpose computer to enable the general-purpose computer to present the sales agent GUI using a web browser software application executed on the general-purpose computer.

14. The method of claim 12, wherein providing the sales agent computer-readable instructions to the general-purpose computer comprises providing, by a repository server, executable code for a sales agent software application to the general-purpose computer, the executable code configured to cause the general-purpose computer to present the sales agent GUI on the electronic display.

15. A vehicle dealership computing system, comprising:
a vehicle dealership manager device configured to present a vehicle dealership manager graphical user interface (GUI) configured to enable a vehicle dealership manager operating the vehicle dealership manager device to control parameters for training an artificial intelligence model to generate deal quality scores; and
a sales agent device configured to:
present a sales agent GUI including input elements configured to receive, from a user operating the sales agent device, vehicle sale information for a proposed vehicle sale of a uniquely identified vehicle;
display a deal quality score for the proposed vehicle sale, the deal quality score generated by the artificial intelligence model based, at least in part, on the vehicle sale information and multifactor estimates of costs incurred by a vehicle dealership for the uniquely identified vehicle, the deal quality score free of an indication of a money value for an estimated profitability of the proposed vehicle sale; and
display an approval decision indicating whether the vehicle sale is approved by the vehicle dealership based, at least in part, on the deal quality score and one or more deal quality score threshold values.

16. The vehicle dealership computing system of claim 15, wherein the vehicle dealership manager GUI is configured to enable the vehicle dealership manager to set the one or more deal quality score threshold values.

17. The vehicle dealership computing system of claim 15, wherein:
the one or more deal quality score threshold values define an automatic approval range of values for the deal quality score; and
the approval decision displayed by the sales agent device automatically indicates that the vehicle sale is approved responsive to a determination that the deal quality score is within the approval range of values.

18. The vehicle dealership computing system of claim 15, wherein:
the one or more deal quality score threshold values define an automatic rejection range of values for the deal quality score; and
the approval decision displayed by the sales agent device automatically indicates that the vehicle sale is rejected responsive to a determination that the deal quality score is within the automatic rejection range of values.

19. The vehicle dealership computing system of claim 18, wherein the one or more deal quality score threshold values include a minimum limit below which the deal quality score triggers an automatic rejection.

20. The vehicle dealership computing system of claim 15, wherein:
the one or more deal quality score threshold values define a manual approval range of values for the deal quality score;
the vehicle dealership manager GUI is configured to prompt the vehicle dealership manager for a manual approval or rejection of the proposed vehicle sale responsive to the deal quality score falling within the manual approval range of values; and
the approval decision displayed by the sales agent device indicates the manual approval or rejection received with the vehicle dealership manager GUI.
